(19) United States
(12) Patent Application Publication
(10) Pub. No.: US 2008/0132222 A1
(43) Pub. Date: Jun. 5, 2008

(54) WIRELESS COMMUNICATION USING A PICOCELL STATION HAVING ITS OWN PHONE NUMBER

(76) Inventor: Colin P. Brady, San Jose, CA (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 11/564,874

(22) Filed: Nov. 30, 2006

(51) Int. Cl. H04Q 7/20

(52) U.S. Cl. 455/422.1

(57) ABSTRACT

A communication system includes a communication device that has its own picocell station phone number. Any one of a plurality of authorized mobile stations communicates over an air interface with the communication device such that the mobile station can participate in a call or a communication session using the picocell station phone number instead of the mobile station's unique mobile phone number. In a disclosed example, a plurality of mobile stations can communicate simultaneously using the picocell station phone number to facilitate a variety of call scenarios.

### 1. TECHNICAL FIELD

This invention generally relates to communication. More particularly, this invention relates to wireless communications.

### 2. DESCRIPTION OF THE RELATED ART

Wireless communication systems are well known and in widespread use. Typical systems include a plurality of base stations strategically positioned to provide wireless communication services over desired geographic areas that are divided into so-called cells. Mobile stations useful for wireless communications in such systems have, therefore, become known as cell phones.

While wireless communications including cell phones have become increasingly available and useful for a wider variety of purposes, there are limitations and those skilled in the art are always striving to make improvements. Mobile stations are typically used for contacting a specific individual who owns the mobile station. Placing a call to a mobile station, however, does not always allow the caller to reach a specific location. Instead, the call is routed to the mobile station wherever that may be located. In general this is not a problem but there are situations where a caller desires to reach several individuals at a single location by placing a single call such as calling a particular home or business. If the individual mobile station to which the call is placed is not located at that home or business, the caller's goal is not obtainable.

Another disadvantage of typical mobile phones is that when a call is placed to a location it is often desirable for multiple parties at that location to share the same telephone connection. In such circumstances, traditional telephones would allow multiple users to participate in the phone call using their own telephone hand set over the same line-based telephone connection. With typical mobile phones, this is not possible and multiple connections are required.

One proposed solution is to allow individuals to carry mobile stations but also maintain a traditional line-based telephone system in a home or business. One disadvantage to such an arrangement is that it requires additional equipment, which introduces additional cost. It also presents a need for paying separately for mobile phone services and line-based phone services.

One proposed arrangement is to use a docking station for a mobile phone. The docking station allows for distributing the radio link between the mobile phone and a base station among a plurality of line-based phones that are appropriately connected with the docking station. In such an example, the phone number of the mobile station (when it is appropriately associated with the docking station) becomes the central phone number for the wired telephones at that location. In such an arrangement, all calls from the wired telephones have to be routed through the docking station and the mobile phone and through the wireless communication network.

Another proposed arrangement includes establishing a so-called picocell within a building or location where it is desirable to extend wireless communication coverage. Such picocells typically include a dedicated base station that communicates wirelessly with individual mobile stations. In such arrangements, however, each mobile station still has to communicate using its own, unique phone number.

There is a need for an improved arrangement that would allow individuals to use their mobile stations while facilitating communications in a manner that resembles features available through line-based systems.

### SUMMARY

An exemplary method of communicating includes using at least one mobile station and a picocell station phone number of a picocell station transceiver instead of a mobile phone number of the at least one mobile station.

One example includes communicating using a plurality of mobile stations simultaneously with each of them using the picocell station phone number.

An exemplary communication device includes a picocell station transceiver that has a picocell station phone number. The picocell station transceiver is configured to communicate over an air interface with a plurality of mobile stations that each have a unique mobile phone number. Any of the plurality of mobile stations can communicate using the picocell station phone number instead of the corresponding mobile phone number.

A disclosed example provides a location-based communication technique in which a plurality of mobile stations can be used for conducting a call directed to or originating from a location in a manner that does not require utilizing the phone number of any of the mobile stations.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a communication system that is useful with an embodiment of this invention.

FIG. 2 schematically illustrates selected portions of a communication device designed according to an embodiment of this invention.

FIG. 3 schematically illustrates an example communication technique useful with an embodiment of this invention.

FIG. 4 schematically illustrates an example communication technique useful with an embodiment of this invention.

FIG. 5 schematically illustrates an example communication technique useful with an embodiment of this invention.

FIG. 6 schematically illustrates an example communication technique useful with an embodiment of this invention.

### DETAILED DESCRIPTION

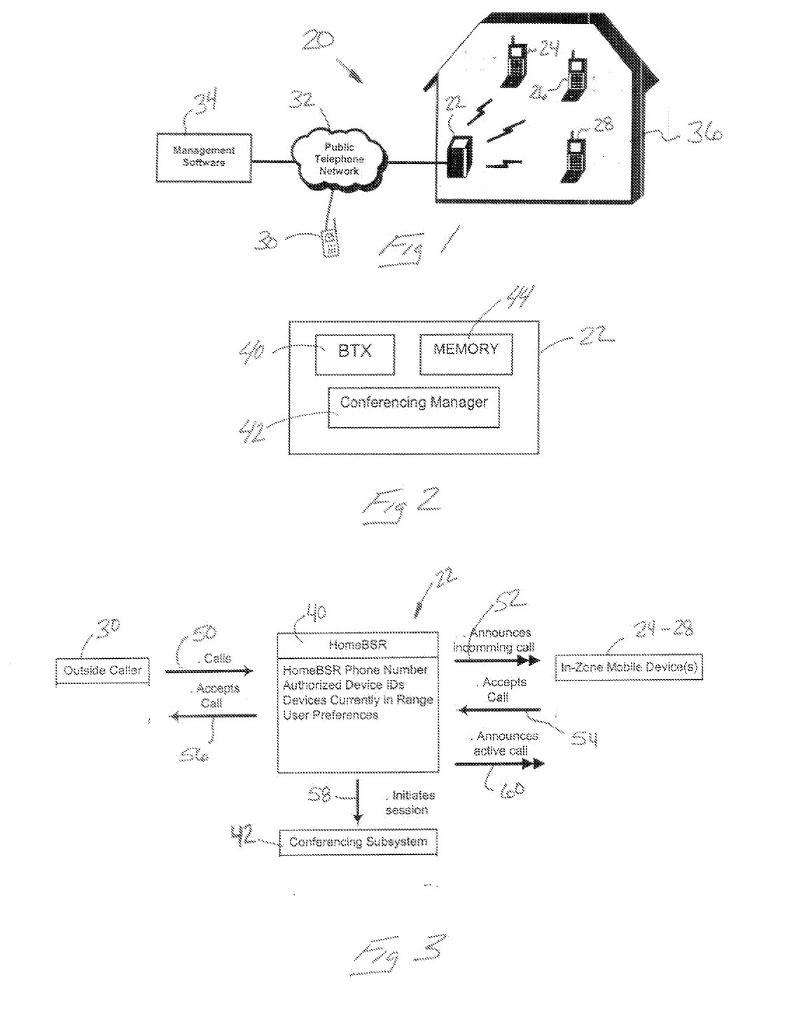

FIG. 1 schematically illustrates selected portions of a communication system 20. In this example, a communication device 22 comprises a picocell station transceiver that communicates over an air interface with a plurality of mobile stations 24, 26 and 28. Each of the mobile stations 24, 26 and 28 has a unique mobile phone number. The over-the-air interface communications between the communication device 22 and the mobile stations 24, 26 and 28 occur in a known manner in one example.

The communication device 22 has its own phone number, which is referred to as a picocell station phone number for purposes of discussion. The picocell station phone number is useful for communications including one or more of the mobile stations 24-28 using the picocell station phone number instead of the unique mobile phone number of the corresponding mobile station(s).

The illustrated device 22 can be considered a picocell station because it provides wireless communication capabilities within a relatively limited area (compared to a macrocell area associated with a traditional base station). The range of the device 22 and the number of mobile stations it can accommodate will depend on the needs of a particular situation. The term “picocell” as used in this description should not necessarily be construed in a strict, limiting sense. For example, a device 22 may provide broadcast coverage over an area that is similar in size to a macrocell coverage area for a dedicated purpose such as instructions to all mobile stations in an area during an emergency situation.

The picocell station phone number can be used for communicating between any one or all of the mobile stations 24-28 and another device 30 such as a remotely located phone. The device 30 may be another mobile station or a line-based telephone, for example. The device 30 communicates with the device 22 through an existing communication network 32 in a known manner. The communication device 22 in the illustrated example communicates through the same network 32. In one example, the communication device 22 communicates with the network 32 using a line-based connection. In another example, wireless communication techniques are used between the network 32 and the communication device 22.

The example of FIG. 1 includes a management software module 34 that is useful for configuring one or more features or operating characteristics of the communication device 22 from a remote location. For example, the management software module 34 may be used for controlling the parameters associated with a contract between a provider and the owner or user of the communication device 22. The management software module 34 may also be used for setting the picocell station phone number such as the identifications of authorized mobile stations that can communicate using the picocell station phone number of the device 22. Other remote management functions may be accomplished using the example management software module 34.

In the illustrated example, the communication device 22 is intended to facilitate communications using at least one of the mobile stations 24-28 within or in the vicinity of a particular building 36. In one example, this provides home phone capability. In another example, this provides communication capabilities within a business. Of course, this invention is not limited to in-building uses and may be used for a variety of so-called picocell arrangements where authorized mobile stations within the coverage area of the picocell device 22 are permitted to communicate using the picocell station phone number of a corresponding communication device 22.

The communication device 22 allows for a call to be placed from the device 30 to the picocell station phone number of the communication device 22 and for an individual to use at least one of the mobile stations 24-28 to answer and conduct that call. Similarly, at least one of the mobile stations 24-28 can be used to initiate a call to the device 30 through the communication device 22 using the picocell station phone number. The communication device 22 allows for conducting communications using at least one of the mobile stations 24-28 and the picocell station phone number instead of the phone number of the corresponding mobile station(s).

In some examples, a device used for communicating according to an embodiment of this invention has an identifier that allows contacting or accessing the device, which is not necessarily a phone number in a technical sense. Accordingly, the term “phone number” as used in this description should be understood to include other device identifiers that are not necessarily used for voice calls, such as an instant messenger ID, for example.

FIG. 2 schematically illustrates selected portions of one example communication device 22. This example includes a picocell station transceiver portion 40 (PTX), a conferencing module 42 and a memory portion 44. The PTX 40 is useful for handling communications with the communication network 32 on the one hand and at least one of the mobile stations 24-28 on the other hand. The conferencing module 42 manages communications conducted through the PTX 40. The memory portion 44 allows for storing information that is useful for the PTX 40, the conferencing module 42 or both. Example types of information maintained within the memory portion 44 include a list of the mobile stations 24-28 that are authorized to use the picocell station phone number of the device 22, the picocell station phone number, a list of mobile stations within range of the device 22 such that they are capable of communicating using the picocell station phone number and any user preferences associated with the device 22 or any of the authorized mobile stations.

The individual portions of the example communication device 22 are schematically shown in FIG. 2 for discussion purposes. Those skilled in the art who have the benefit of this description will realize that various functions of these portions may be distributed differently among components or may be shared among components, depending on the particular embodiments. Given this description, those skilled in the art will realize what hardware, software or combination of them will best meet their particular needs for realizing a communication device having a picocell station phone number consistent with the disclosed example.

FIG. 3 schematically illustrates one approach at facilitating a communication session between the example device 30 and the location associated with the communication device 22. In this example, the call is initiated at 50 by an individual placing a call using the device 30 in a known manner. The call is routed through the communication network 32 to the picocell station transceiver 40 of the device 22 because the call at 50 was directed to the picocell station phone number. Upon receiving the call, the PTX 40 announces the call at 52 to any available one of the plurality of mobile stations 24-28. In one example, the available mobile stations play a ringtone, display a visible indication or both to indicate the incoming call. At least one individual uses at least one of those mobile stations for receiving or accepting the call. This is communicated to the PTX 40 as schematically shown at 54. The PTX 40 then communicates through the network 32 as schematically shown at 56 to accept the call from the device 30.

In the example of FIG. 3, the conferencing module 42 initiates a conferencing session at 58 at the same time or about the same time that the PTX 40 communicates the acceptance of the call at 56. In the illustrated example, the conferencing module 42 maintains information such as the originating caller ID and a list of any of the mobile stations 24-28 that are currently involved in the call. At any time, more than one of the mobile stations 24-28 can be used to conduct the call that was directed to the picocell station phone number. The conferencing module 42 facilitates simultaneous access to the picocell station phone number by a plurality of the mobile stations 24-28 without requiring any of the mobile stations to use its own, unique mobile phone number.

In the example of FIG. 3, the PTX 40 announces the active call at 60 to any available mobile station 24-28 that is within a communication range of the device 22. In the example of FIG. 3, the PTX 40 maintains information including a list of the devices that are currently within communicating range of the device 22.

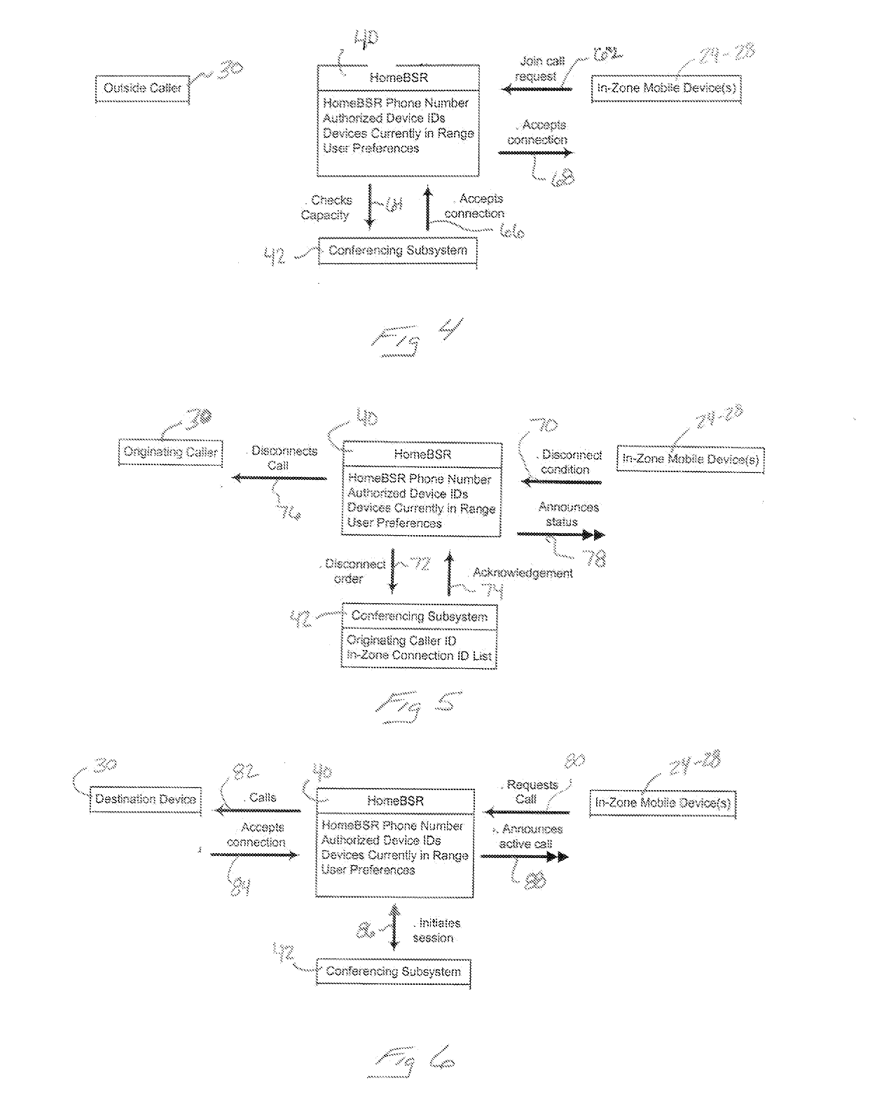

FIG. 4 schematically shows one example approach for allowing a user of one of the mobile stations 24-28 to join a call that is already in progress. As schematically shown at 62, a request is made for accessing the picocell station phone number by one of the mobile stations. The request schematically shown at 62 is received by the PTX 40 and it is communicated to the conferencing module 42 as schematically shown at 64. In this example, the conferencing module 42 makes a determination whether it is possible to grant the access request at 62. The conferencing module 42 in one example determines a capacity of the PTX 40 for handling communications in an existing call with another mobile station. In another example, the conferencing module 42 determines whether the particular mobile station making the request has sufficient authorization or priority to be included into the ongoing call. A caller ID function is useful for determining which mobile station is making the request. The determination whether to grant the requested access is communicated to the PTX 40 at 66 and then to the requesting mobile station at 68.

In the example of FIG. 4, the access request was granted. If the determination is made to deny the access request, that is communicated to the mobile station in the same manner as schematically shown in FIG. 4.

FIG. 5 schematically shows one approach to handling a situation where one of the mobile stations 24-28 disconnects from an ongoing communication session (e.g., the user hangs up during a telephone call). When the mobile station 26, for example, disconnects as schematically shown at 70, the PTX 40 receives an indication of the disconnect condition. The PTX 40 communicates that to the conferencing module 42 at 72. The conferencing module 42 updates the information regarding the call status including the list of mobile stations currently active in the call and acknowledges the disconnect at 74. The PTX 40 disconnects the call from the device 30 at 76 and provides an announcement or indication at 78 to any remaining mobile stations 24-28 still participating in the call. Such an indication may be audible or visible.

In the event that the conferencing module 42 determines that the disconnecting mobile station is the last mobile station to have participated in the call, that is communicated to the PTX 40. The connection with the device 30 is then entirely disconnected at 76 and a new status announcement at 78 is sent to the mobile stations 24-28 indicating that the communication device 22 is no longer being used and is available for receiving or initiating another call.

FIG. 6 schematically shows an example approach to allowing an individual to use one of the mobile stations 24-28 to initiate a phone call using the picocell station phone number of the communication device 22 instead of using the unique mobile phone number of the corresponding mobile station. In FIG. 6, one of the mobile stations 24-28 is used to initiate a call by placing a request schematically shown at 80 from the corresponding mobile station to the PTX 40. In one example, the mobile stations 24-28 contact the PTX 40 for this purpose by dialing the picocell station phone number. The mobile station can then be used to enter the phone number that should be called. In another example, the request made at 80 is accomplished by sending a short message service (SMS) format message from a corresponding mobile station to the communication device 22. In another example, a dedicated protocol useful for communications between the mobile stations 24-28 and the communication device 22 facilitates making the request schematically shown at 80.

The PTX 40 responds to the request by dialing the intended number so that the call originates using the picocell station phone number for reaching the intended number. This is schematically shown at 82. The call is answered and the connection is accepted at 84. Once the request at 80 is placed, the PTX 40 communicates with the conferencing module 42 so that the status of the call can be monitored within the conferencing module 42 including identifying the devices involved in the call and the status of whether the device 30 has been used to accept the call, for example. This is schematically shown at 86. Once the appropriate connections have been established and the call can be conducted, that is announced at 88 to the mobile station used for initiating the call. Additionally, an indication is provided to the other mobile stations regarding the current status of communications using the picocell station phone number of the communication device 22.

In one example, the mobile stations do not require modification so that a variety of types of mobile stations may be used with the communication device 22. In such an example, a mobile station can dial the picocell station phone number or a dedicated access code to communicate with a device 22 indicating a desire to initiate a new call. Answering a call occurs just as if the mobile phone number were dialed. The wireless communications between the device 22 and the mobile stations 24-28 for purposes of handling an ongoing communication session occur using known techniques or a customized protocol taking advantage of existing capabilities of the mobile stations.

An advantage associated with the disclosed example arrangement is that it is readily implemented for a variety of situations to provide the convenience and capability experienced with line-based phones while using existing mobile stations. Additionally, the disclosed example provides the benefit of allowing an individual to use their mobile station without having to use their unique mobile phone number. This can provide a cost savings because individuals do not require two separate phones for two separate functions. It also increases convenience.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A communication device, comprising:
a picocell station transceiver that has a picocell station phone number and is configured to communicate over an air interface with a plurality of mobile stations that each have a unique mobile phone number such that any of the plurality of mobile stations can communicate using the picocell station phone number instead of the corresponding unique mobile phone number.

2. The device of claim 1, wherein the picocell station transceiver is configured to permit more than one of the plurality of mobile stations to simultaneously communicate using the picocell station phone number.

3. The device of claim 1, comprising
a conferencing module for managing a communication session that includes the picocell station transceiver and at least one of the mobile stations.

4. The device of claim 3, wherein at least one of the picocell station transceiver or the conferencing module determines a status of the call;
notifies any available ones of the plurality of mobile stations of the determined status; and
facilitates participation in the call by a user using an available one of the mobile stations.

5. The device of claim 3, wherein the conferencing module is configured to determine whether to grant a requested access from one of the mobile stations and to provide an indication for communicating the determination to at least the one of the mobile stations.

6. The device of claim 1, comprising
a memory portion configured to maintain
a list of the plurality of mobile stations authorized to communicate using the picocell station phone number and
a list of any of the mobile stations actively participating in a current communication session.

7. The device of claim 1, wherein the picocell station transceiver
determines when a call is placed from an outside caller to the picocell station phone number; and
notifies any available ones of the plurality of mobile stations of the call.

8. The device of claim 7, wherein the picocell station transceiver communicates with a notified mobile station to allow a user of the notified mobile station to answer the call, using the notified mobile station.

9. The device of claim 1, wherein the picocell station transceiver is configured to allow any of the mobile stations to place a call to another device using the picocell station phone number.

10. The device of claim 1, wherein the picocell station transceiver is configured to communicate with a telephony network through at least one of a line-based connection or an over-the-air interface using the picocell station phone number.

11. A method of communicating, comprising
using at least one mobile station and a picocell station phone number of a picocell station transceiver instead of a mobile phone number of the at least one mobile station.

12. The method of claim 11, comprising
simultaneously using the picocell station phone number by a plurality of mobile stations, each having a unique mobile phone number.

13. The method of claim 11, comprising
managing a communication session that includes the picocell station transceiver and the at least one of the mobile stations.

14. The method of claim 11, comprising
maintaining a list of the plurality of mobile stations authorized to communicate using the picocell station phone number and
determining a list of any of the mobile stations actively participating in a current communication session.

15. The method of claim 11, comprising
determining whether to grant a requested access from one of the mobile stations; and
communicating the determination to at least the one of the mobile stations.

16. The method of claim 13, comprising
determining when a call is placed from an outside caller to the picocell station phone number; and
notifying any available ones of the plurality of mobile stations of the call.

17. The method of claim 16, comprising
communicating with a notified mobile station to allow a user of the notified mobile station to answer the call, using the notified mobile station.

18. The method of claim 17, comprising
determining a status of the call;
notifying any available mobile stations of the plurality of mobile stations of the determined status; and
facilitating participation in the call by a user using an available one of the mobile stations.

19. The method of claim 11, comprising
allowing any of the mobile stations to place a call to another device using the picocell station phone number.

20. The method of claim 11, comprising
communicating between the picocell station transceiver and a telephony network through at least one of a line-based connection or an over-the-air interface using the picocell station phone number.
